(19) United States
(12) Patent Application Publication
(10) Pub. No.: US 2011/0115594 A1
(43) Pub. Date: May 19, 2011

(54) MAGNETIC ELEMENT, FABRICATING PROCESS THEREOF, AND ASSEMBLY OF MAGNETIC ELEMENT AND CIRCUIT CARRIER

(75) Inventor: Chun-Ching Yen, Taoyuan Hsien (TW)

(73) Assignee: DELTA ELECTRONICS, INC., Taoyuan Hsien (TW)

(21) Appl. No.: 12/946,086

(22) Filed: Nov. 15, 2010

(30) Foreign Application Priority Data
Nov. 16, 2009 (TW) 098138884

(51) Int. Cl. H01F 27/29; H01F 7/06

(52) U.S. Cl. 336/192; 29/605

(57) ABSTRACT

A magnetic element includes a bobbin, a pin pedestal, and a coil. The bobbin includes a connecting base with at least one first wire-arranging groove. The pin pedestal is connected to the connecting base, and includes a pedestal body and at least one pin. The pin is disposed on the pedestal body. The coil is wound around the bobbin, and has an outlet part. The outlet part is penetrated through the first wire-arranging groove, moved across the pedestal body and fixed on the pin.

### FIELD OF THE INVENTION

The present invention relates to a magnetic element, and more particularly to a magnetic element with reduced overall width. The present invention also relates to a fabricating process of the magnetic element, and an assembly of the magnetic element and a circuit carrier.

### BACKGROUND OF THE INVENTION

Nowadays, magnetic elements such as inductors and transformers are widely used in many electronic devices to generate induced magnetic fluxes. The uses of the magnetic elements may achieve the functions of storing energy, resonating, choking a current, filtering or converting electric energy.

Take an inductor for example. A conventional inductor usually comprises a bobbin, a magnetic core assembly, and a coil. The coil is wound around a winding section of the bobbin. When an electric current received by the inductor is subject to a change, the coil interacts with the magnetic core assembly, and thus the inductor generates an induced electromotive force. In addition, the bobbin has several pins. At least one outlet part of the coil is soldered and fixed on a corresponding pin. These pins may be inserted into corresponding perforations of a printed circuit board to facilitate fixing the inductor on the circuit board.

For reducing the overall height of the electronic device, the inductor is usually mounted on a printed circuit board (PCB) according to a breakout PCB mounting technology. The term “breakout PCB mounting technology” means that a portion of the inductor is accommodated within a hollow portion of the printed circuit board (PCB). By the breakout PCB mounting technology, the pins of the inductor are extended from a top edge of the bobbin. If the pins are bent downwardly toward the printed circuit board, the pins usually become hindrance from winding the coil. For solving this drawback, the pins are bent to have L-shapes in order to increase the winding space of winding the coil around the winding section of the bobbin.

FIG. 1 is a schematic exploded view illustrating a conventional inductor. As shown in FIG. 1, the conventional inductor comprises a magnetic core assembly 11, a bobbin 12 and a coil 13. The coil 13 is wound around a winding section 121 of the bobbin 12. The magnetic core assembly 11 is partially embedded into the inner portion of the bobbin 12. In addition to the winding section 121, the bobbin 12 further comprises two pin pedestals 122 and plural pins 123. The two pin pedestals 122 are disposed on the top surface of the bobbin 12 and arranged on opposite sides of the bobbin 12. The pins 123 are L-shaped in order to increase the winding space of winding the coil 13 around the winding section 121 of the bobbin 12. Each of the pins 123 comprises a support part 123a and an insertion part 123b. The support part 123a is embedded into and protruded from an edge of the corresponding pin pedestal 122. The outlet parts (not shown) of the coil 13 are soldered on corresponding support part 123a. The distal end of the insertion part 123b is bent downwardly such that the insertion part 123b is perpendicular to the support part 123a. The insertion part 123b is inserted into a corresponding perforation of a printed circuit board (not shown). As such, the inductor 1 is fixed on the printed circuit board. Since the pins 123 are disposed on the pin pedestals 122 that are disposed on the top surface of the bobbin 12, the inductor 1 could be mounted on a printed circuit board (PCB) according to the breakout PCB mounting technology.

Although the inductor 1 could be mounted on the printed circuit board according to the breakout PCB mounting technology, there are still some drawbacks. For example, since the pin 123 is L-shaped and the support part 123a of the pin 123 is protruded from an edge of the corresponding pin pedestal 122, the support part 123a should have a length H. Due to the length H of the support part 123a, the overall width of the inductor 1 is increased. That is, the inductor 1 mounted on the printed circuit board according to the breakout PCB mounting technology will occupy much space of the printed circuit board. Recently, since the electronic devices are developed toward minimization, the space utilization of the printed circuit board should be further enhanced.

Moreover, since the distal ends of the insertion parts 123b are bent downwardly and the insertion parts 123b are perpendicular to the support parts 123a, the insertion parts 123b are usually not aligned with each other and fail to be precisely inserted into corresponding perforations of the printed circuit board. Under this circumstance, the process of mounting the inductor 1 on the printed circuit board is time-consuming and labor-intensive.

For obviating the drawbacks encountered from the prior art, there is a need of providing a magnetic element, a fabricating process of the magnetic element, and an assembly of the magnetic element and a circuit carrier.

### SUMMARY OF THE INVENTION

It is an object of the present invention to provide a magnetic element with reduced overall width.

An object of the present invention provides an assembly of a magnetic element and a circuit carrier, in which the pins of the magnetic element are precisely aligned with corresponding perforations of the circuit carrier, and the space utilization of the circuit carrier is enhanced.

A further object of the present invention provides a simplified and time-saving process of fabricating the magnetic element.

In accordance with an aspect of the present invention, there is provided a magnetic element. The magnetic element includes a bobbin, a pin pedestal, and a coil. The bobbin includes a connecting base with at least one first wire-arranging groove. The pin pedestal is connected to the connecting base, and includes a pedestal body and at least one pin. The pin is disposed on the pedestal body. The coil is wound around the bobbin, and has an outlet part. The outlet part is penetrated through the first wire-arranging groove, moved across the pedestal body and fixed on the pin.

In accordance with another aspect of the present invention, there is provided an assembly of a magnetic element and a circuit carrier. The magnetic element includes a bobbin, a pin pedestal, and a coil. The bobbin includes a connecting base with at least one first wire-arranging groove. The pin pedestal is connected to the connecting base, and includes a pedestal body and at least one pin. The pin is disposed on the pedestal body. The coil is wound around the bobbin, and has an outlet part. The outlet part is penetrated through the first wire-arranging groove, moved across the pedestal body and fixed on the pin. The circuit carrier includes at least one perforation and a hollow portion. The perforation is arranged beside the hollow portion. The pin is aligned with and inserted into the perforation. The magnetic element is partially accommodated within the hollow portion.

In accordance with a further aspect of the present invention, there is provided a fabricating process of a magnetic element. The magnetic element includes a bobbin, a pin pedestal, a coil and a magnetic core assembly. The bobbin includes a connecting base with at least one first wire-arranging groove and a first coupling part. The pin pedestal includes at least one pin and a second coupling part. The coil has an outlet part. The process includes steps of: (a) winding the coil around the bobbin, and allowing the outlet part to be penetrated through the first wire-arranging groove; (b) allowing the first coupling part and the second coupling part to be engaged with each other, so that the pin pedestal is connected with the connecting base; (c) fixing the outlet part on the pin; and (d) partially embedding the magnetic core assembly into the bobbin.

In accordance with a further aspect of the present invention, there is provided a magnetic element. The magnetic element includes a bobbin, a pin pedestal, and a coil. The bobbin includes a connecting base. The pin pedestal is connected to the connecting base, and includes a pedestal body, at least one pin and at least one wire-arranging groove. The pin and the wire-arranging groove are disposed on the pedestal body. The coil is wound around the bobbin, and has an outlet part. The outlet part is penetrated through the wire-arranging groove, moved across the pedestal body and fixed on the pin.

The above contents of the present invention will become more readily apparent to those ordinarily skilled in the art after reviewing the following detailed description and accompanying drawings, in which:

### BRIEF DESCRIPTION OF THE DRAWINGS

FIG. 1 is a schematic exploded view illustrating a conventional inductor;

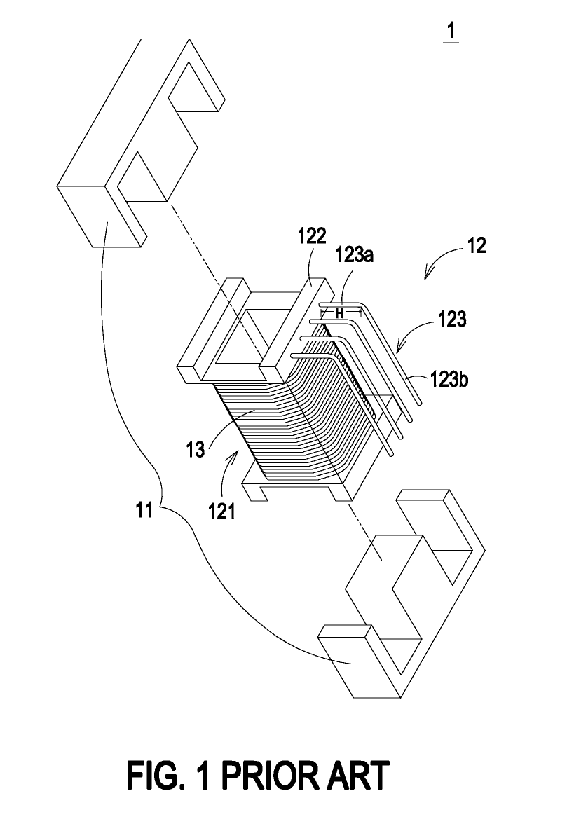

FIG. 2 is a schematic exploded view illustrating a magnetic element according to an embodiment of the present invention;

FIG. 3 is a schematic assembled view illustrating the magnetic element of FIG. 2;

FIG. 4 is a flowchart illustrating a process of assembling the magnetic element of FIG. 2;

FIG. 5 is a schematic exploded view illustrating the magnetic element of FIG. 3 to be mounted on a circuit carrier; and

FIG. 6 is a schematic side view illustrating the assembly of the magnetic element and the circuit carrier as shown in FIG. 5.

### DETAILED DESCRIPTION OF THE PREFERRED EMBODIMENT

The present invention will now be described more specifically with reference to the following embodiments. It is to be noted that the following descriptions of preferred embodiments of this invention are presented herein for purpose of illustration and description only. It is not intended to be exhaustive or to be limited to the precise form disclosed.

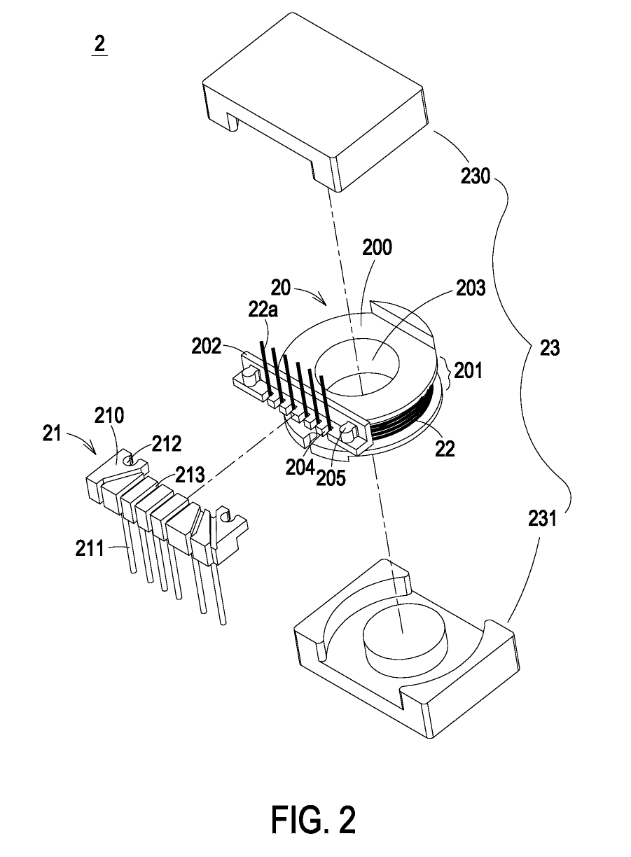

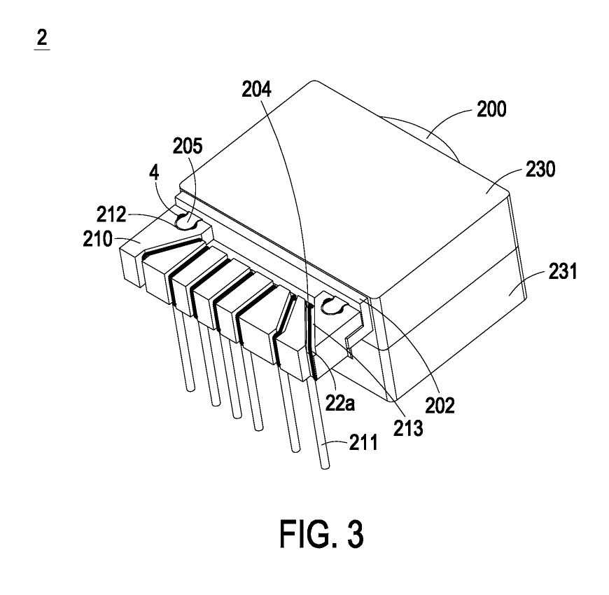

FIG. 2 is a schematic exploded view illustrating a magnetic element according to an embodiment of the present invention. FIG. 3 is a schematic assembled view illustrating the magnetic element of FIG. 2. In this embodiment, the magnetic element 2 is an inductor. Alternatively, the magnetic element 2 is a transformer. The magnetic element 2 comprises a bobbin 20, a pin pedestal 21, a coil 22 and a magnetic core assembly 23. The magnetic core assembly 23 comprises a first magnetic part 230 and a second magnetic part 231. The coil 22 includes at least one conductive wire, which is a single-core wires or a multiple strand wire. In addition, the coil 22 has plural outlet parts 22a.

The bobbin 20 comprises a bobbin body 200, a winding section 201 and a connecting base 202. The bobbin body 200 has a channel 203. The first magnetic part 230 and the second magnetic part 231 are partially embedded in the channel 203. The winding section 201 is disposed on the outer periphery of the bobbin body 200. The coil 22 is wound around the winding section 201.

The connecting base 202 is integrally formed with the bobbin body 200, and externally extended from a side edge of a top surface of the bobbin body 200. The connecting base 202 comprises plural first wire-arranging grooves 204 and plural first coupling parts 205. In this embodiment, the connecting base 202 comprises two first coupling parts 205, which are arranged at bilateral sides of the connecting base 202. The first wire-arranging grooves 204 are arranged between these two first coupling parts 205. After the coil 22 is wound around the winding section 201, the outlet parts 22a are penetrated through the first wire-arranging grooves 204 from bottom to top. As a consequence, these outlet parts 22a are separated from each other.

The pin pedestal 21 is detachably connected with the connecting base 202. The pin pedestal 21 comprises a pedestal body 210, plural pins 211 and plural second coupling parts 212. The second coupling parts 212 are disposed on the pedestal body 210 and at the locations corresponding to the first coupling parts 205. When the second coupling parts 212 are engaged with the first coupling parts 205, the pin pedestal 21 is connected with the connecting base 202. The pins 211 are disposed on and perpendicular to the bottom surface of the pedestal body 210. After the pin pedestal 21 is connected with the connecting base 202, the outlet parts 22a could be soldered and fixed on corresponding pins 211 via solder paste (not shown). In this embodiment, the pins 211 are made of conductive material and have cylindrical shapes.

In some embodiments, the first coupling parts 205 are convex structures, and the second coupling parts 212 are clamping structures mating with respective convex structures. The configurations of the first coupling parts 205 and the second coupling parts 212 are not restricted to those shown in FIG. 2 as long as the first coupling parts 205 and the second coupling parts 212 could be engaged with each other. In this embodiment, the first coupling parts 205 and the second coupling parts 212 are parallel with each other, so that the pin pedestal 21 is connected with the connecting base 202 in parallel. Moreover, after the second coupling parts 212 are engaged with the first coupling parts 205, an adhesive 4 may be applied on the jointing regions between the first coupling parts 205 and the second coupling parts 212 in order to facilitate engagement between the first coupling parts 205 and the second coupling parts 212.

In some embodiments, the pin pedestal 21 further comprises plural second wire-arranging grooves 213 corresponding to the first wire-arranging grooves 204 of the connecting base 202. After the pin pedestal 21 and the connecting base 202 are connected with each other, the outlet parts 22a that have been penetrated through the first wire-arranging grooves 204 will be accommodated within respective second wire-arranging grooves 213 and then soldered on respective pins 211. In other words, the uses of the second wire-arranging grooves 213 may facilitate positioning the outlet parts 22a and separating the outlet parts 22a.

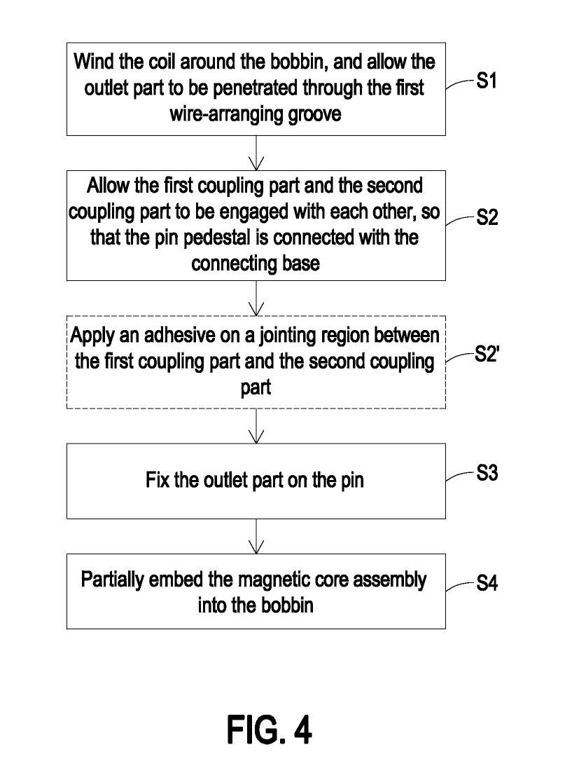

FIG. 4 is a flowchart illustrating a process of assembling the magnetic element of FIG. 2. Hereinafter, a process of assembling the magnetic element of the present invention will be illustrated with reference to FIGS. 2, 3 and 4. First of all, the coil 22 is wound around the winding section 201 of the bobbin 20 and the outlet parts 22a of the coil 22 are penetrated through the first wire-arranging grooves 204 from bottom to top (Step S1). Next, the first coupling parts 205 and the second coupling parts 212 are engaged with each other such that the pin pedestal 21 is connected with the connecting base 202 (Step S2). Next, the outlet parts 22a that have been penetrated through the first wire-arranging grooves 204 are accommodated within respective second wire-arranging grooves 213 and then soldered on respective pins 211 (Step S3). Afterwards, the first magnetic part 230 and the second magnetic part 231 of the magnetic core assembly 23 are partially embedded into the channel 203 of the bobbin 20 (Step S4). The resulting structure of the magnetic element 2 is shown in FIG. 3.

In some embodiments, after Step S2 and before Step S3, the process further includes a step of applying an adhesive 4 on the jointing regions between the first coupling parts 205 and the second coupling parts 212 (see FIG. 3) in order to facilitate engagement between the first coupling parts 205 and the second coupling parts 212 (Step S2′).

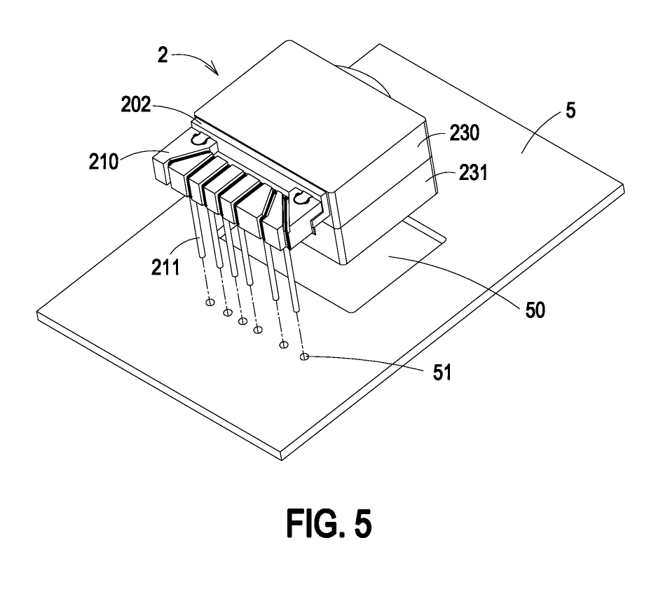

Please refer to FIG. 2 again. The pin pedestal 21 is detachably connected with the connecting base 202. In other words, the pin pedestal 21 is connected with the connecting base 202 after the coil 22 is wound around the winding section 201 of the bobbin 20. As a consequence, the pins 211 no longer become hindrance from winding the coil 22 around the winding section 201. Since the pins 211 are vertically protruded from the bottom surface of the pedestal body 210 and not bent into L-shapes, the overall width of the magnetic element 2 is reduced when compared with the prior art. After the magnetic element 2 is mounted on a circuit carrier 5 (As shown in FIG. 5), the space utilization of the circuit carrier 5 is enhanced and thus the overall volume of the electronic device is reduced. Moreover, since the pins 211 are vertically protruded from the bottom surface of the pedestal body 210 and not bent into L-shapes, the pins 211 could be precisely aligned with corresponding perforations of the circuit carrier 5. Under this circumstance, the process of mounting the magnetic element 2 on the circuit carrier 5 is simplified and time-saving.

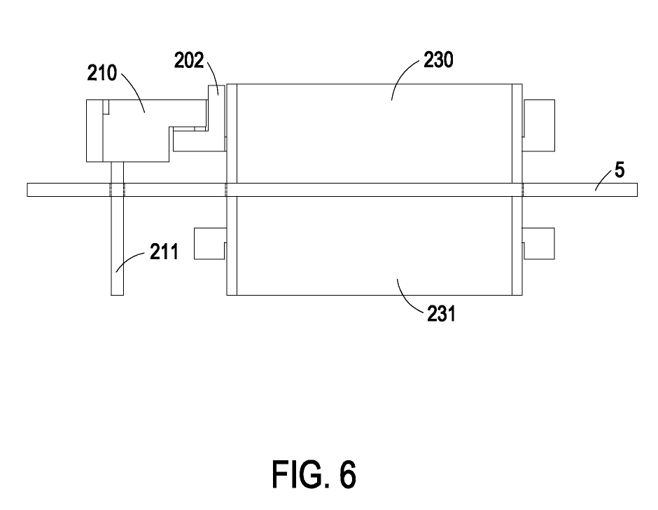

Hereinafter, a process of mounting the magnetic element of the present invention on a circuit carrier will be illustrated with reference to FIGS. 5 and 6. FIG. 5 is a schematic exploded view illustrating the magnetic element of FIG. 3 to be mounted on a circuit carrier. FIG. 6 is a schematic side view illustrating the assembly of the magnetic element and the circuit carrier as shown in FIG. 5. Please refer to FIGS. 5 and 6. In this embodiment, the circuit carrier 5 is a printed circuit board (PCB), and the magnetic element 2 is mounted on the circuit carrier 5 according to the breakout PCB mounting technology. The circuit carrier 5 has a hollow portion 50 and plural perforations 51. The perforations 51 are arranged beside the hollow portion 50 and corresponding to the pins 211 of the magnetic element 2. The pins 211 are inserted into corresponding perforations 51. The size of the hollow portion 50 is dependent on the dimension of the magnetic element 2. During the pins 211 are inserted into corresponding perforations 51, the magnetic element 2 is partially accommodated within the hollow portion 50. In such manner, the magnetic element 2 is mounted on the circuit carrier 5 according to the breakout PCB mounting technology. As such, the overall height of the magnetic element mounted on the circuit carrier 5 is reduced.

From the above description, since the pin pedestal is detachably connected to the connecting base, the pins no longer become hindrance from winding the coil around the winding section. Since the pins are vertically protruded from the bottom surface of the pedestal body and not bent into L-shapes, the overall width of the magnetic element is reduced when compared with the prior art. After the magnetic element is mounted on a circuit carrier, the space utilization of the circuit carrier is enhanced and thus the overall volume of the electronic device is reduced. Moreover, since the pins are vertically protruded from the bottom surface of the pedestal body and not bent into L-shapes, the pins could be precisely aligned with corresponding perforations of the circuit carrier. Under this circumstance, the process of mounting the magnetic element on the circuit carrier is simplified and time-saving. Moreover, the uses of the first wire-arranging grooves and the second wire-arranging grooves may facilitate positioning the outlet parts and separating the outlet parts.

While the invention has been described in terms of what is presently considered to be the most practical and preferred embodiments, it is to be understood that the invention needs not be limited to the disclosed embodiment. On the contrary, it is intended to cover various modifications and similar arrangements included within the spirit and scope of the appended claims which are to be accorded with the broadest interpretation so as to encompass all such modifications and similar structures.

What is claimed is:

1. A magnetic element comprising:
a bobbin comprising a connecting base with at least one first wire-arranging groove;
a pin pedestal connected to said connecting base, and comprising a pedestal body and at least one pin, wherein said pin is disposed on said pedestal body; and
a coil wound around said bobbin, and having an outlet part, wherein said outlet part is penetrated through said first wire-arranging groove, moved across said pedestal body and fixed on said pin.

2. The magnetic element according to claim 1 wherein said bobbin further comprises a bobbin body with a channel.

3. The magnetic element according to claim 2 wherein said connecting base is integrally formed with said bobbin body, and externally extended from a side edge of a top surface of said bobbin body.

4. The magnetic element according to claim 2 further comprising a magnetic core assembly, which is partially embedded into said channel.

5. The magnetic element according to claim 4 wherein said magnetic core assembly comprises a first magnetic part and a second magnetic part.

6. The magnetic element according to claim 1 wherein said bobbin further comprises a winding section, and said coil is wound around said winding section of said bobbin.

7. The magnetic element according to claim 1 wherein said coil is a conductive wire.

8. The magnetic element according to claim 1 wherein said bobbin further comprises a first coupling part, which is disposed on said connecting base.

9. The magnetic element according to claim 8 wherein said pin pedestal further comprises a second coupling part, which is disposed on said pedestal body and corresponding to said first coupling part, wherein said pin pedestal is detachably connected with said connecting base when said first coupling part and said second coupling part are engaged with each other.

10. The magnetic element according to claim 9 wherein said first coupling part is a convex structure, and said second coupling part is a clamping structure.

11. The magnetic element according to claim 1 wherein said pins are vertically protruded from a bottom surface of said pedestal body.

12. The magnetic element according to claim 1 wherein said pins have cylindrical shapes.

13. The magnetic element according to claim 1 wherein said pin pedestal further comprises a second wire-arranging groove, which is disposed on said pedestal body and corresponding to said first wire-arranging groove, wherein said outlet part that has been penetrated through said first wire-arranging groove is further accommodated within said second wire-arranging groove.

14. The magnetic element according to claim 1 wherein said magnetic element is an inductor or a transformer.

15. The magnetic element according to claim 1 wherein said pin pedestal is connected with said connecting base in parallel.

16. An assembly of a magnetic element and a circuit carrier, said assembly comprising:
said magnetic element comprising:
a bobbin comprising a connecting base with at least one first wire-arranging groove;
a pin pedestal connected to said connecting base, and comprising a pedestal body and at least one pin, wherein said pin is disposed on said pedestal body; and
a coil wound around said bobbin, and having an outlet part, wherein said outlet part is penetrated through said first wire-arranging groove, moved across said pedestal body and fixed on said pin; and
said circuit carrier comprising at least one perforation and a hollow portion, wherein said perforation is arranged beside said hollow portion, said pin is aligned with and inserted into said perforation, and said magnetic element is partially accommodated within said hollow portion.

17. The assembly according to claim 16 wherein said circuit carrier is a printed circuit board.

18. A fabricating process of a magnetic element, said magnetic element comprising a bobbin, a pin pedestal, a coil and a magnetic core assembly, said bobbin comprising a connecting base with at least one first wire-arranging groove and a first coupling part, said pin pedestal comprising at least one pin and a second coupling part, said coil having an outlet part, said fabricating process comprising steps of:
(a) winding said coil around said bobbin, and allowing said outlet part to be penetrated through said first wire-arranging groove;
(b) allowing said first coupling part and said second coupling part to be engaged with each other, so that said pin pedestal is connected with said connecting base;
(c) fixing said outlet part on said pin; and
(d) partially embedding said magnetic core assembly into said bobbin.

19. The fabricating process according to claim 18 wherein said pin pedestal further comprises a second wire-arranging groove corresponding to said first wire-arranging groove, and said step (c) further comprises a sub-step of partially accommodating said outlet part within said second wire-arranging groove.

20. The fabricating process according to claim 18 wherein after said step (b), said fabricating process further comprises a step (b1) of applying an adhesive on a jointing region between said first coupling part and said second coupling part.

21. A magnetic element comprising:
a bobbin comprising a connecting base;
a pin pedestal connected to said connecting base, and comprising a pedestal body, at least one pin and at least one wire-arranging groove, wherein said pin and said wire-arranging groove are disposed on said pedestal body; and
a coil wound around said bobbin, and having an outlet part, wherein said outlet part is penetrated through said wire-arranging groove, moved across said pedestal body and fixed on said pin.
